(19) United States
(12) Patent Application Publication
(10) Pub. No.: US 2002/0024166 A1
(43) Pub. Date: Feb. 28, 2002

(54) Punch and die

(76) Inventors: Hiroshi Fukada, Toyonaka-shi (JP); Hiroshi Matoba, Osaka-shi (JP); Etsuji Nakamura, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/874,067

(22) Filed: Jun. 6, 2001

(30) Foreign Application Priority Data
Jun. 16, 2000 (JP) 182039/2000

(51) Int. Cl. B29C 43/02

(52) U.S. Cl. 264/123; 425/352; 425/470

(57) ABSTRACT

An object of the present invention is to provide a punch or die having excellent corrosion resistance and releasing property which is suitable for a tablet machine particularly for the production of tablets containing corrosive substance(s) and adhesive substance(s). Thus, the present invention relates to a punch or die for compressing granules to prepare tablets, where a high-silicon steel is used as a basis material.

### BACKGROUND OF THE INVENTION

1. Field of the Invention

The present invention relates to a punch or a die for compressing granules to prepare tablets which has excellent corrosion resistance and releasing property and is used for the preparation of tablets containing corrosive substances such as an acidic substance or adhesive substances such as adhesive pharmacologically active substance, low-melting substance or pharmaceutical excipient.

The present invention further relates to a tablet machine equipped with such a tablet punch or die, to a method for manufacturing tablets using the said tablet machine and to tablets manufactured by the said manufacturing method.

2. Description of the Related Art

Punch and die for the manufacture of tablets should not be easily deformed by the above-mentioned compressing operation which is frequently repeated and, therefore, they are requested to have a high mechanical strength. Until now, they are prepared using alloy super steel or alloy tool steel and, further, those where chromium plating or the like is applied on the punch surface as a countermeasure for corrosion and adhesion have been used as well.

In the above-mentioned conventional punch and die using alloy tool steel or the like, the metal material therefor inherently has a property of being easily corroded and, especially when the granules for compression contains corrosive substances such as an acidic substance, corrosion of the metal material is apt to progress much more whereby corrosion may occur during the manufacture of tablets and there is a problem that the life as punch and die is significantly reduced.

When such a corrosion occurs in punch and die, a slipping property of the surface of punch and die and a releasing property from the granules to be tabletted lower and, as a result, tablets are hardly taken out from the die and, in addition, the granules adheres on the surface of punch and die whereby the surface of the resulting tablet becomes rough or a clear mark is unable to be formed on the table surface or, in some cases, foreign substances resulted by the above corrosion may contaminate the tablets.

In addition, when the granules to be compressed contains adhesive substances such as an adhesive pharmacologically active substance, low-melting substance or pharmaceutical excipient, the releasing property of the said tablet from punch and die lowers and the tablets are hardly taken out from the die hole and, further, sticking is resulted and the said granules sticks onto the surface of punch tip whereby there are problems that the surface of tablets becomes rough and clear mark is unable to be formed on the surface of tablets. Furthermore, a binding takes place when the tablets are taken out from the die and the tablets are hardly taken out. The term “binding” means a scratch on the side of the tablets which occurs when the slippage between the tablets prepared and the surface of die bore is not smooth.

Further, in order to improve corrosion resistance and releasing property, a coating such as a chromium plating may be applied on the surface of punch and die made of the above-mentioned alloy tool steel but a sufficient effect is not sometimes available because the coating layer is not uniform or the detachment of the coating layer is inherently unavoidable.

### SUMMARY OF THE INVENTION

An object of the present invention is to provide a punch or die having excellent corrosion resistance and releasing property which is suitable for a tablet machine particularly for the production of tablets containing corrosive substances and adhesive substances.

In order to solve the above-mentioned problems, the present inventors have carried out an intensive investigation and found that corrosion resistance is improved when a high-silicon steel is used as a basis material for the tablet punch or die. They have further unexpectedly found that, even in the case of the granules for compressing granules to prepare tablets containing adhesive substances, the punch or die using such a high-silicon steel as a basis material has a very good releasing property between the said granules for preparing tablets and the surface of punch or die. Particularly with regard to a die, a binding very rarely takes place.

It has been further found that corrosion resistance and releasing property are further improved when the surface of the punch or die using the said high-silicon steel as a basis material is subjected to a carburization treatment. It has been furthermore found that such a carburization treatment is able to solve the problems such as detachment of a coating layer in a coating treatment such as a chromium plating and is able to achieve such an industrially advantageous merit that durability of the tabletting punch or die is improved.

As a result of a still further investigation, the present inventors have achieved the present invention.

Thus, the present invention relates to:

[1] A punch or die for compressing granules to prepare tablets where basis material is a high-silicon steel.

[2] The punch or die according to the above [1], wherein the surface of the basis material is subjected to a carburization treatment.

[3] The punch or die according to the above [1] or [2], wherein it is applied to a punch (1, 2) or die (3) used for a tablet machine for the preparation of tablets containing corrosive substances or adhesive substances.

[4] The punch or die according to the above [3], wherein the corrosive substance is an acidic substance.

[5] The punch or die according to the above [3], wherein the adhesive substance(s) is/are one or more substance(s) selected from a group consisting of adhesive pharmacologically active substance, adhesive low-melting substance and adhesive excipient.

[6] The punch or die according to the above [5], wherein the adhesive low-melting substance is resulted due to a depression of melting point.

[7] A tablet machine which is characterized in being equipped with the punch or the die mentioned in the above [1] or [2].

[8] A method for manufacturing tablets, characterized in that, the tablet machine mentioned in the above [7] is used during compression of granules.

[9] The method according to the above [8], wherein the tablets contain corrosive substances or adhesive substances.

[10] The manufacturing method according to the above[9], wherein the corrosive substance is an acidic substance.

[11] The manufacturing method according to the above[9], wherein the adhesive substance(s) is/are one or more substance(s) selected from a group consisting of adhesive pharmacologically active substance, adhesive low-melting substance and adhesive excipient.

[12] The manufacturing method according to the above [11], wherein the adhesive low-melting substance is resulted due to a depression of melting point.

[13] Tablets which are manufactured according to the manufacturing method mentioned in the above [8] to [12].

### BRIEF DESCRIPTION OF THE DRAWINGS

FIG. 1 is an outline of cross-sectional view of a rotary tablet machine using the tabletting punch or die according to the present invention.

FIG. 2 is an embodiment of an apparatus for carrying out the carburization treatment in the present invention.

FIG. 3 shows the tabletting punch and die used in the Examples.

Explanation of reference letters or numerals:

1 rotary tablet machine

2 die table

3 die

3a die bore

4 upper punch

5 supporting disk for upper punch

6 lower punch

7 supporting disk for lower punch

8 guide rails for upper punch

9 guide rails for lower punch

10 granules

21 furnace

22 heater

23 fan

24 case wherein punch or die is packed

25 CO gas tank

26 introducing pipe for introduction of N₂ and H₂ wherefrom N₂ gas and H₂ gas are introduced

27 introducing pipe for introduction of carburizing gas

28 exhaust pipe

29 exhaust waste gas pipe

31 upper punch

32 lower punch

33 die

34 granules

35a, 35b holder for punch or die

36 pressing part for compression

37 base of tablet machine

### DETAILED DESCRIPTION OF THE PREFERRED EMBODIMENTS

With regard to the high-silicon steel used for the punch or die of the present invention, an Fe—Si alloy containing about 2 to 10% by weight or, preferably, 2 to 5% by weight of silicon may be exemplified. It is possible to improve the corrosion resistance and releasing property of the punch and die when Si is contained therein. Due to excellent hardness or abrasion resistance, it is also possible to improve the durability of the tabletting machine as well.

In the conventional tough hardening steel, the toughness is given mostly by the action of carbon while, in the high-silicon steel, it is attempted to increase the strength by silicon in place of carbon. Accordingly, the high-silicon steel of the present invention may further contain not more than about 0.1% by weight or, preferably, not more than about 0.08% by weight of carbon.

The high-silicon steel of the present invention may furthermore contain Ni, Mn or Cr. When Ni is added, a risk of embrittlement caused by the use of large amount of silicon can be reduced and, when Cr is added, corrosion resistance and abrasion resistance can be improved together with Si.

The amount of Ni is about 1 to 20% by weight, preferably about 4 to 16% by weight or, more preferably, about 4 to 10% by weight. The amount of Mn is about 0 to 6% by weight or, preferably, about 0.05 to 3% by weight. The amount of Cr is about 5 to 25% by weight, preferably about 6 to 16% by weight or, more preferably, about 6 to 12% by weight.

It is a preferred embodiment of the present invention when the total amount of Ni and Mn is about 1.5 to 2.5-fold or, preferably, about 2-fold of the amount of Si. Further, it is a preferred embodiment of the present invention when the amount of Cr is about 2.5 to 3.5-fold or, preferably, about 3-fold of the amount of Si.

The high-silicon steel of the present invention may still furthermore contain Mo, Co, W, V, Ti, Ta, Al, Cu, Nb or the like.

The amount of Mo is about 0 to 6% by weight or, preferably, about 0.2 to 5% by weight. The amount of Co is about 0 to 25% by weight or, preferably, about 0.5 to 20% by weight. The amount of W is about 0 to 4% by weight or, preferably, about 0 to 2% by weight. The amount of V is about 0 to 4% by weight. The amount of Ti is about 0 to 3% by weight or, preferably, about 0.1 to 2% by weight. The amount of Ta is about 0 to 10% by weight or, preferably, about 0 to 8% by weight. The amount of Al is preferably about 0 to 1% by weight. The amount of Cu is about 0 to 6% by weight. The amount of Nb is preferably about 0 to 5% by weight.

With regard to the preferred embodiments of the high-silicon steel of the present invention, the following five embodiments may be exemplified.

(1) a high-silicon steel in which C is about 0 to 0.08% by weight, Si is about 3.5 to 6% by weight, Mn is about 0 to 5% by weight, Ni is about 3 to 9% by weight, Cr is about 6 to 15% by weight and Fe is in balance, total amount of Ni and Mn is about 2-fold of the amount of Si, the amount of Cr is about 2.5-fold of the amount of Si and the transformation temperature for A₃ is not higher than about 750° C.;

(2) a high-silicon steel in which C is about 0 to 0.05% by weight, Si is about 3.5 to 6% by weight, Mn is about 2 to 6% by weight, Ni is about 1 to 4% by weight, Cr is about 8 to 16% by weight, Mo is about 0.3 to 3% by weight, Cu is about 1 to 4% by weight and Fe is in balance, total amount of Ni, Mn and Cu is about 2.5-fold of the amount of Si, the amount of Cr is about 3-fold of the amount of Si and the transformation temperature for A₃ is not higher than about 750° C.;

(3) a high-silicon steel in which C is about 0 to 0.1% by weight, Si is about 4 to 9% by weight, Mn is about 0 to 3% by weight, Ni is about 6 to 18% by weight, Cr is about 16 to 25% by weight, Mo is about 0 to 3% by weight, Co is about 0 to 3% by weight and/or Cu is about 0 to 2% by weight and Fe is in balance, total amount of Ni and Mn is about 2-fold of the amount of Si, the amount of Cr is about 3.5-fold of the amount of Si and the transformation temperature for A₃ is not higher than about 750° C.;

(4) a high-silicon steel in which C is about 0 to 0.05% by weight, Si is about 4 to 7% by weight, Mn is about 0 to 3% by weight, Ni is about 6 to 16% by weight, Cr is about 12 to 20% by weight, V is about 0 to 4% by weight, Mo is about 0 to 4% by weight, W is about 0 to 4% by weight, Ti is about 0 to 1% by weight, Al is about 0 to 1% by weight and/or Co is about 0 to 1% by weight, Cu is about 0 to 1% by weight and Fe is in balance, total amount of Ni and Mn is about 2-fold of the amount of Si, the amount of Cr is about 3.5-fold of the amount of Si and the transformation temperature for A₃ is not higher than about 750° C.; and

(5) a high-silicon steel in which C is about 0 to 0.05% by weight, Si is about 2 to 4% by weight, Mn is about 0 to 2% by weight, Ni is about 5 to 10% by weight, Cr is about 8 to 13% by weight, Mo is about 0.2 to 1% by weight, Cu is about 0.5 to 3% by weight and Fe is in balance, and the sum of the 2 times amount of Cr and the amount of Si is about 20-30% by weight of the whole amount.

More preferred embodiment of the high-silicon steel according to the present invention is a high-silicon steel in which C is about 0 to 0.08% by weight, Si is about 2 to 5% by weight, Mn is about 0.05 to 3% by weight, Ni is about 4 to 10% by weight, Cr is about 6 to 12% by weight, Mo is about 0.2 to 5% by weight, Cu is about 0 to 6% by weight, Ti is not more than about 0.1 to 2% by weight, Co is not more than about 0.5 to 20% by weight, Ta is about 0 to 8% by weight, Nb is about 0 to 5% by weight and Fe is in balance. Among them, the above-mentioned high-silicon steel of a precipitation hardening type is preferred.

The high-silicon steel of the present invention can be manufactured by known methods or by the methods similar thereto.

On the basis of a microscopic tissue of the steel material, the stainless steel is classified into an austenite type, a ferrite type, an austenite-ferrite type, a martensite type and a precipitation hardening type. The high-silicon steel of the present invention may be in any of those types although that of an austenite type or a precipitation hardening type is preferred.

Surface of the punch or die used in the present invention may be subjected to a carburization treatment.

With regard to a carburization treatment carried out in the present invention, the particularly preferred treatment is that where carbon atoms form an interstitial solid solution among the lattice atoms of the basis material and thereby a concentrated carbon layer is formed on the surface of the basis material.

In the punch or die where the basis material surface is subjected to a carburization treatment, the concentrated carbon layer formed on the surface layer is hard and there are advantages that not only the corrosion resistance of the basis material using a high-silicon steel is rarely deteriorated but also, in some cases, higher corrosion resistance than the basis material is achieved.

It is appropriate to conduct the treatment so that the depth of the concentrated carbon layer on the basis material surface from the surface becomes about 5-100 μm or, preferably, about 50-100 μm.

In addition, it is preferred that the surface carbon concentration in the said concentrated carbon layer is made about 1.2 to 2.6% by weight. As a result of formation of interstitial solid solution of carbon, lattice of the basis material in the concentrated carbon layer is subjected to a distorted expansion isotropically and hardens by the said distortion and it is preferred that the surface carbon concentration is within the above-mentioned value since the distortion becomes much more and the surface hardness is further improved.

The said carburization treatment is preferably carried out by contacting to a gas for carburization containing CO. As a result of this carburization treatment, the so-called Boudouard reaction as shown by the following formula (1) takes place whereby carbon is separated on the surface of the basis material, forms an interstitial solid solution among the lattice atoms of the basis material and a concentrated carbon layer is formed on the surface.

2CO→C+CO₂ (1)

Examples of the gas for carburization used in the carburization treatment are a gas comprising a mixed gas of CO and H₂ and a modified gas represented by RX gas (composition of the RX gas is 23% by volume of CO, 1% by volume of CO₂, 31% by volume of H₂, 1% by volume of H₂O and N₂ in balance).

When the mixing ratio of the carburization gas is changred, the carbon concentration on the surface can be adjusted.

Since penetration of carbon atoms into the basis material metal follows a diffusion rule in general, depth of the concentrated carbon layer is dependent upon the treating temperature and the treating time. Therefore, a carburization treatment may be carried out by setting a treating time by which a necessary concentrated carbon layer depth can be achieved and the treating time is about 10 to 30 hours or, preferably, about 15 to 25 hours.

Temperature for carrying out the carburization treatment is about 400 to 700° C. or, preferably, about 400 to 500° C. This is because it is preferred that the carburization treatment is carried out at such a low temperature that the core is neither softened nor gives a solution and also because the corrosion resistance is dependent upon the treating temperature (the lower the temperature, the better the corrosion resistance).

Thus, it is preferred to carry out the treatment at about 400 to 700° C. which is lower than the A₁ transformation temperature of carbon steel. Further, when the corrosion resistance which is same as or better than the basis material is aimed in addition to the surface rigidity, it is preferred to further lower the carburization treatment temperature setting at 400 to 500° C.

In the present invention, a pre-treatment may be carried out before the carburization treatment. Examples of the pre-treatment are a treatment with a chloride and a fluorinating treatment.

An example of the treatment with a chloride is a method where the tabletting punch or die according to the present invention is heated in an atmosphere of a chlorine-type gas and then a carburization treatment is conducted.

As a result of the treatment with a chloride, metal on the basis material surface forms a chloride membrane and, at the same time, the immobile membrane formed on the basis material surface is destroyed whereby a carburization at the low temperature region of lower than about 700° C. or, rather, lower than about 500° C. is possible.

Examples of the chlorine type gas used in the said chloride treatment are gaseous HCl; gas prepared by making liquid CH₂Cl₂, CH₃Cl or the like into a gaseous state; and gas prepared by making solid NH₄Cl, FeCl₂ or the like into a gaseous state. Besides them, it is also possible to use a gas which is prepared by making other chlorine compounds containing Cl in a molecule into a gaseous state (hereinafter, referred to as “chlorine compound gas”). Two or more thereof may be mixed and used as well.

It is also possible to use a chlorine gas prepared by a thermal decomposition of such a chlorine compound gas by a thermal decomposition apparatus or a previously prepared chlorine gas as the said chlorine type gas.

Among them, HCl which is gaseous at ambient temperature is best in view of good workability and handling.

Although the above-mentioned chlorine type gas may be used solely, it is usually used by diluting with inert gas such as N₂ gas. Degree of dilution (concentration) of the HCl gas to N₂ gas, etc. at that time is preferably about 1 to 20% by volume or, more preferably, about 3 to 10% by volume taking a balance between the treating efficiency and the prevention of consumption of the furnace material into consideration.

During the said chloride treatment, it is preferred that the chlorine type gas is introduced to an extent of about 1 to 5 g/m³. This is because introduction of excessive chlorine type gas accelerates the consumption of the furnace material and also increases a load of the exhaust gas treating apparatus.

In order to prevent the consumption of the furnace material, it is also preferred that the treating temperature by the chlorine type gas is set at about 200 to 400° C. or, preferably, about 250 to 350° C.

The retention time of the above heating is preferably set at about 5 to 20 minutes.

The chloride film such as FeCl₂, FeCl₃, CrCl₂, CrCl₃, etc. formed during the chloride treating reacts with H₂ in the atmospheric gas for carburization during the carburization treatment to give HCl. Accordingly, it is preferred that this HCl is introduced into an exhaust gas pipe, converted to CaCl₂ in an exhaust gas treating apparatus of a dry type equipped therein, captured and made harmless.

An example of the fluorinating treatment is a method where the tabletting punch or die according to the present invention is heated in an atmosphere of fluorine-type gas and then subjected to a carburization treatment. Incidentally, the above fluorinating treatment may be carried out together with the carburization treatment.

As a result of the fluorinating treatment, an immobile film containing Cr₂O₃, etc. formed on the basis material surface is converted to a fluorinated membrane. As compared with the above immobile film, this fluorinated membrane is presumed to make the penetration of carbon atom easy—the carbon atom being used for the carburization—and it is expected that the basis material surface becomes a surface state wherethrough the carbon atom is easily penetrated by the above fluorinating treatment.

Examples of the fluorine type gas used for the said fluorinating treatment are NF₃, BF₃, CF₄, HF, SF₆, C₂F₆, WF₆, CHF₃, SiF₄, ClF₃, etc. and each of them may be used solely or two or more thereof may be used together. Besides the above ones, it is also possible to use other fluorine type compound containing fluorine in a molecule which is made into a gaseous state as the fluorine compound gas.

It is further possible to use a fluorine gas produced by a thermal decomposition of such a fluorine compound gas using a thermal decomposition apparatus or a previously prepared fluorine gas as the fluorine-type gas. Such a fluorine compound gas and fluorine gas may be used by mixing in some cases.

With regard to such a fluorine type gas, NF₃ is preferred. This is because NF₃ is gaseous at ambient temperature and has a high chemical stability whereby its handling is easy.

Each of the above-mentioned fluorine compound gas and fluorine type gas such as fluorine gas may be used as it is but, usually, it is used after diluting with inert gas such as N₂ gas.

Concentration of the fluorine type gas in such a diluted gas on the basis of volume is about 10,000 to 100,000 ppm, preferably about 20,000 to 70,000 ppm or, more preferably, about 30,000 to 50,000 ppm.

The more preferred embodiment of the above-mentioned fluorinating treatment is that, for example, anon-treated punch or die is placed in a furnace and is kept in a heated state in an atmosphere of the fluorine type gas having the above concentration. In that case, retention of heating is carried out by keeping the punch or die itself at the temperature of about 250 to 600° C. or, preferably, about 250 to 500° C.

It is preferred that the retention time of heating in such above fluorine type gas atmosphere is set at about 10 to 80 minutes.

With regard to the carburization treatment in the present invention, preferred embodiments will be more specifically illustrated.

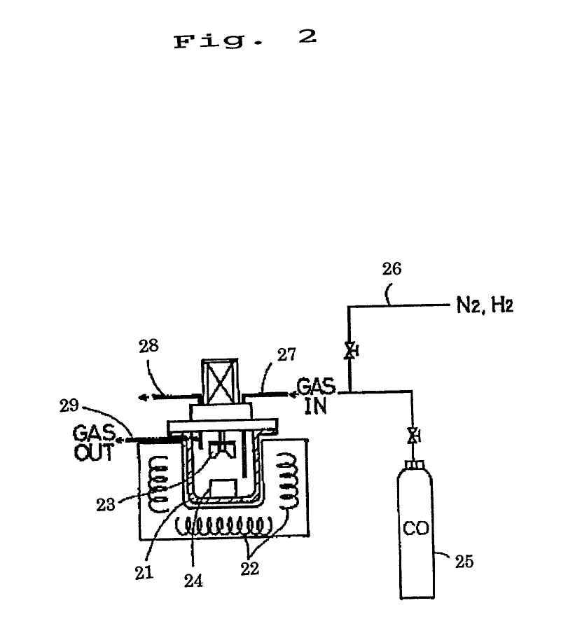

The carburization treatment of the present invention may be carried out using a furnace shown by FIG. 2 for example. In the said drawing, 21 is a furnace body; 22 is a heater; 23 is a fan; 24 is a case wherein the punch or die is packed; 25 is a CO gas tank; 26 is an introducing pipe for introduction of N₂ and H₂ wherefrom N₂ gas and H₂ gas are introduced; the above-mentioned CO gas, N₂ gas or H₂ gas is mixed in a predetermined mixing ratio and introduced into a furnace from a pipe 27 for introduction of the carburization gas; 28 is an exhaust pipe which makes the inner part of the furnace vacuum by means of a vacuum pump (not shown); and 29 is an exhaust pipe by which the exhaust gas in the furnace is exhausted.

In the above furnace, surfaces of the parts contacting to the carburization gas such as inner wall of the furnace body 21, heater 22, fan 23 and case 24 are composed of nickel.

When a chloride treatment or a fluorinating treatment is carried out optionally, temperature is raised with optionally conducting a purge of the furnace using N₂ gas, carburization gas such as a mixed gas of 11% by volume of CO, 15% by volume of H₂, 72% by volume of N₂ and 2% by volume of CO₂ is introduced thereinto and a carburization treatment is carried out by keeping for a predetermined time, the concentrated carbon layer formed on the surface, and the punch and die treated by carburization is taken out.

With regard to the carburization treatment condition at that time, it is preferred to conduct a carburization treatment at about 400 to 500° C. for about 10 to 30 hours in order to form, for example, a concentrated carbon layer of not less than 25 μm and also to make the said concentrated carbon layer more corrosion-resistant than the basis material.

Here, the surface of the punch or die of the present invention after the carburization treatment becomes black due to adhesion of soot and also to oxidation of the outermost layer part.

Accordingly, in order to obtain a metal gloss inherent to metal in the present invention, a mechanical abrasion such as an emery paper, a puff abrasion or a barrel abrasion is carried out or a surface washing is carried out by dipping in an acid such as an HF—HNO₃ solution heated at about 60 to 70° C. whereby the above-mentioned black layer can be removed. This washing with an acid is effective in reinforcing the corrosion resistance by regeneration of an immobile film on the surface of the tabletting punch or die of the present invention after the carburization treatment.

The basis material may be subjected to coating with Cr-Dopé-N treatment by the known method, e.g. sputtering method, for example as described in Kata Gijyutsu (Mold Technique) Vol. 8, No. 5 (April 1993), pages 70-78.

The punch or die according to the present invention can be also appropriately used for the manufacture of tablets containing, for example, a corrosive acidic substance, adhesive pharmacologically active substance, excipient or low-melting substance, a substance which results in a depression of melting point due to two or more components contained therein, etc.

There is no particular limitation for the said substance but any substance may be used. Thus, the tabletting punch or die of the present invention may be used not only for pharmaceuticals containing pharmacologically active substances but also for agricultural chemicals, fertilizers, foods, plastics, ceramics, metal, etc.

Examples of the corrosive acidic substance are pioglitazone hydrochloride, manidipine hydrochloride, delapril hydrochloride, fursultiamine hydrochloride, cefotiam hexetil hydrochloride, thiamin hydrochloride, hydroxylysine hydrochloride and pyridoxine hydrochloride. Incidentally, the acidic substance in the present invention is not particularly limited thereto but any substance may be used so far as it is an acidic solid substance.

Examples of the adhesive pharmacologically active substance are ibuprofen, 3-[1-(phenylmethyl)piperidin-4-yl]-1-(2,3,4,5-tetrahydro-1H-1-benzazepin-8-yl)-1-propanone fumarate, risedronate, pioglitazone hydrochloride and tocopherol compounds.

Incidentally, the adhesive pharmacologically active substance in the present invention is not particularly limited thereto but any substance may be used so far as it is a pharmacologically active substance showing an adhesive property.

In addition, when the granules for tabletting contains an adhesive excipient, the pharmacologically active substance may not be adhesive. Examples of the pharmacologically active substance which may be used in the present invention even when it has no adhesive property are lansoprazole, candesartan cilexetil, vinpocetine, seratrodast, phenylpropanolamine hydrochloride, dextromethorphan hydrobromide, anhydrous caffeine, chlorpheniramine d-maleate, acetaminophen, tranexamic acid, dihydrocodeine phosphate, methylephedrine hydrochloride and noscapine.

Incidentally, the pharmacologically active substance which may be used in the present invention even if having no adhesive property is not particularly limited thereto but any pharmacologically active substance may be used.

With regard to a excipient having an adhesive property, sugar alcohol is particularly available and its examples are erythritol, D-mannitol, D-sorbitol, xylitol, maltitol, anhydrous maltose, hydrous maltose, anhydrous lactitol, hydrous lactitol and powdery reduced maltose syrup.

Incidentally, the excipient having an adhesive property in the present invention is not particularly limited thereto but any excipient having an adhesive property may be used.

Examples of a low-melting substance having an adhesive property are tocopherol substances, ketoprofen and ibuprofen.

Incidentally, the low-melting substance having an adhesive property in the present invention is not particularly limited thereto but any low-melting substance having an adhesive property may be used.

Examples of the substance which causes a melting point depression by two or more ingredients are pharmaceutical component consisting of a combination of chlorpheniramine (such as chlorpheniramine d-maleate or chlorpheniramine dl-maleate) with dextromethorphan hydrobromide, a combination of acetaminophen with dextromethorphan hydrobromide, a combination of nicotinamide with d-α-tocopherol succinate, a combination of nicotinamide with fursultiamine hydrochloride, a combination of guaiphenesin with dextromethorphan hydrobromide and a combination of guaiphenesin with chlorpheniramine d-maleate.

Incidentally, the substance causing a depression of melting point by two or more ingredients in the present invention is not particularly limited thereto but any substance causing a depression of melting point by two or more ingredients may be used.

With regard to the tablets, anything may be used so far as they have a shape of tablet and it goes without saying that they may be tablets containing medicine-containing fine granules, pellets or the like and also multilayered tablets or core-having tablets with an object of prevention of contact of medicines, control of release or improvement in administration. It is also possible that the tablets are further subjected to a surface coating by a conventional method to manufacture a product.

With regard to the above pharmacologically active substance, it is usually made into granules for tabletting by mixing, for example, with excipient, lubricant or disintegrating agent and then compressed using the tabletting punch and die of the present invention to manufacture the tablets.

If necessary, the granules for preparing tablets may be further compounded with additives for the preparations such as antiseptic agent, antioxidant, coloring agent or corrigent.

Examples of the excipient are lactose, starch (such as cornstarch, potato starch and wheat starch), pregelatinized starch, partly pregelatinized starch, microcrystalline cellulose (such as Avicel PH101 and Avicel PHF20 [both are trade names; manufactured by Asahi Chemical Industry]), light anhydrous silicic acid (such as Sylysia 320 [trade name; manufactured by Y.K.F.]), magnesium carbonate, calcium carbonate, low-substituted hydroxypropylcellulose, carboxymethylcellulose calcium, magnesium alumino metasilicate, synthetic aluminum silicate, sucrose, glucose, dextrin, acacia and aqueous glucose.

Examples of the lubricant are polyethyleneglycol, talc, stearic acid and sucrose ester of fatty acid.

Examples of the said sucrose ester of fatty acid are sucrose ester of fatty acid having a molecular weight of about 400 to 1300 (such as sucrose laurate, sucrose myristate, sucrose palmitate and sucrose stearate).

Examples of the sucrose laurate are sucrose monolaurate, sucrose dilaurate and sucrose trilaurate.

Examples of the sucrose myristate are sucrose monomyristate, sucrose dimyristate and sucrose trimyristate.

Examples of the sucrose palmitate are sucrose monopalmitate, sucrose dipalmitate and sucrose tripalmitate.

Examples of the sucrose stearate are sucrose monostearate, sucrose distearate and sucrose tristearate.

Examples of the binder are sucrose, gelatin, powdered acacia, methylcellulose, hydroxypropyl cellulose (such as HPC-L), hydroxypropylmethylcellulose, carboxymethyl cellulose, carboxymethylcellulose sodium, polyvinylpyrrolidone, pullulan, dextrin, pregelatinized starch and trehalose.

Examples of disintegrating agent are carboxymethyl cellulose calcium, crosscarmellose sodium (such as AcDiSol [trade name; manufactured by Asahi Chemical Industry]), cross-linked insoluble polyvinylpyrrolidone (such as Kollidon CL [trade name; manufactured by BASF]), low-substituted hydroxypropyl cellulose, partly pregelatinized starch, cross povidone (ISP Inc., BASF), carmellose calcium (manufactured by Gotoku Yakuhin), carboxymethylstarch sodium (manufactured by Matsutani Kagaku) and cornstarch.

Examples of the coating agent are hydroxypropyl methylcellulose, hydroxymethylcellulose, hydroxypropyl cellulose, ethylcellulose, carboxymethylethylcellulose, polyoxyethyleneglycol, Pluronic F68, Tween 80, castor oil, cellulose acetate phthalate, hydroxymethyl cellulose acetate succinate, aminoalkyl methacrylate copolymer (such as Eudragit E and Eudragit RS), methacrylic acid copolymer (such as Eudragit L30-55), waxes and dyes such as talc, titanium oxide and red ferric oxide.

Examples of the coloring agent are tar dyes, caramel, red ferric oxide, titanium oxide, riboflavin compounds, green tea extract, copper chlorophyllin sodium, edible dyes such as Yellow #5, food Red #2 and food Blue #2 and edible lake dyes.

Examples of the corrigent are sweetener (such as artificial sweeteners including saccharin sodium, dipotassium glycyrrhizinate, aspartame, stevia and thaumatin), perfume (such as lemon, lemon lime, orange, l-menthol, peppermint oil, peppermint micron X-8277-T and dry coat matcha #421), acidic agent (such as citric acid, tartaric acid and malic acid) and powdered green tea.

Amount of the corrosive acidic substance or adhesive pharmacologically active substance or low-melting substance in the granules for compressing to prepare tablets cannot be defined sweepingly but is within a broad range. To be more specific, it is about 0.001 to 99.5%, preferably about 0.01 to 70% and, more preferably, about 0.1 to 50%.

Amount of the adhesive filler in the granules for preparing tablets cannot be defined sweepingly but is within a broad range as well. To be more specific, it is about 0.001 to 99.5%, preferably about 0.01 to 90% and, more preferably, about 0.1 to 90%.

Tablets can be manufactured by compressing the granules for preparing tablets using a tablet machine equipped with the punch or die according to the present invention.

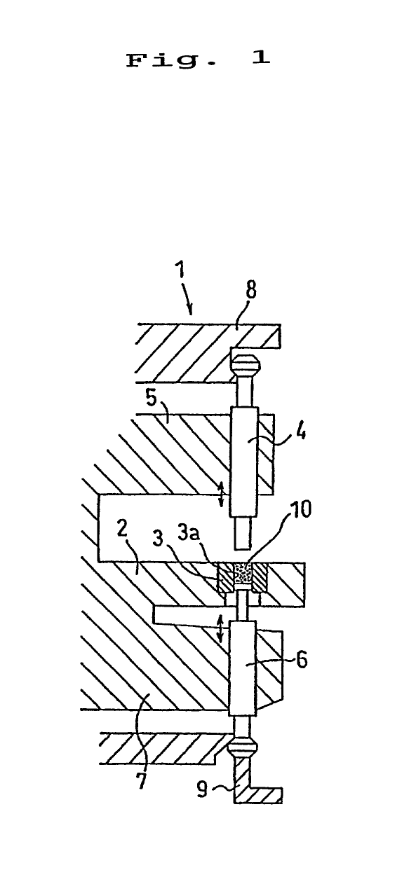

A preferred embodiment of the tablet machine equipped with the punch or die according to the present invention and that of the method for the manufacture of tablets using the said tablet machine will be illustrated by referring to FIG. 1.

A die bore (3a) is formed in a die (3) attached to a die table, position of the lower punch (6) located under the die bore is adjusted so that the space in the die bore (3a) is set at a predetermined volume, granules for preparing tablets (10) such as powdery medicine is placed in the die bore (3a) and compressed with an upper punch (4) to form tablets and, after that, the tablets are pushed up by a lower punch (6) so that the said tablets are taken out from the die bore whereupon the tablets are manufactured.

Compression force is usually about 1 to 30 kN/punch, preferably about 5 to 30 kN/punch and, more preferably, about 8 to 25 kN/punch.

Inner diameter of the die is usually about 3 to 20 mm, preferably about 3 to 13 mm and, more preferably, about 4 to 10 mm. Shape of the die may be circular or may be others such as oval or oblong.

The symbol % throughout the specification means percentage by weight basis unless otherwise noted.

### EXAMPLES

### Example 1-1

In accordance with the formulation as shown in Table 1, each of the ingredients of group I comprising 270 g of ibuprofen, 14.4 g of dihydrocodeine phosphate, 557.4 g of lactose, 89.1 g of cornstarch, 36 g of crosscarmellose sodium and 14.4 g of hydroxypropylmethylcellulose was placed in a fluidized bed granulator (FD-3SN; manufactured by Powrex Company), mixed and granulated with 520 g of a 6 wt % aqueous solution of hydroxypropyl cellulose at the rate of 12 g/minute together with supply of air of 60° C. to prepare granules. They were milled using a screening mill (manufactured by Showa Kagaku Kikai) (screen size: 1.5 mm) to give granules in a uniform size. With regard to group P, 150 g of phenylpropanolamine hydrochloride, 15 g of chlorpheniramine maleate, 150 of anhydrous caffeine, 5 g of lactose and 363 g of cornstarch in accordance with the formulation of Table 1 were placed in a fluidized bed granulator (temperature of supplied air: 80° C.), granulated with 367 g of a 6 wt % aqueous solution of hydroxypropylcellulose at the rate of 8 g/minute and the resulting granules were milled in the same manner as above to give granules in a uniform size.

To 843.75 g of granules of the group I in a uniform size and 176.25 g of granules of the group P in a uniform size were added 127 g of microcrystalline cellulose, 48 g of crosscarmellose sodium and 5 g of magnesium stearate, the mixture was mixed for 3 minutes in a diffusion mixer (type TM-15; manufactured by Showa Kagaku Kikai) and the resulting granules for tabletting were treated with a rotary tablet machine (Correct 19k; manufactured by Kikusui Seisakusho) with a compression force of 15 kN/punch to manufacture tablets. At that time, an oblong punch (13.5 mm×6.5 mm) (having marks both on top and bottom) and die were used. The punch used there was that a high-silicon steel (type Silicolloy SL-X2; manufactured by Nippon Silicolloy Kogyo) was used as a basis material and its surface was subjected to the carburization treatment as mentioned above while SKS-2 was used as a basis material of the die and the surface was untreated.

### Comparative Example 1-1

The granules prepared in Example 1-1 were treated with a rotary tablet machine (Correct 19k; manufactured by Kikusui Seisakusho) with a compression force of 15 kN/punch to prepare tablets. At that time, an oblong punch of 13.5 mm×6.5 mm having marks both on top and bottom and a die were used. Both punch and die used SKS-2 as a basis material where the surface of the punch was subjected to a chromium plating while the surface of the die was untreated.

TABLE 1

| | Ex.1-1 and Comp. Ex. 1-1 |
|---|---|
| per six tablets | [mg] |
| Group I | |
| Ibuprofen | 450.0 |
| Dihydrocodeine phosphate | 24.0 |
| Lactose | 929.0 |
| Cornstarch | 148.5 |
| Crosscarmellose sodium | 60.0 |
| Hydroxypropylmethylcellulose | 24.0 |
| Hydroxypropylcellulose | 52.0 |
| Total | 1687.5 |
| Group P | |
| Phenylpropanolamine hydrochloride | 75.0 |
| Chlorpheniramine maleate | 7.5 |
| Anhydrous caffeine | 75.0 |
| Lactose | 2.5 |
| Cornstarch | 181.5 |
| Hydroxypropylcellulose | 11.0 |
| Total | 352.5 |
| After Mixing | |
| Group I granules | 1687.5 |
| Group P granules | 352.5 |
| Microcrystallinecellulose | 254.0 |
| Crosscarmellose sodium | 96.0 |
| Magnesium stearate | 10.0 |
| Total | 2400.0 |

### Example 1-2

In accordance with the formulation as shown in Table 2, each of the ingredients of group A comprising 900 g of acetaminophen, 60 g of dl-methylephedrine hydrochloride, 37.2 g of hesperidin and 254.1 g of cornstarch was placed in a fluidized bed granulator (FD-3SN; manufactured by Powrex Company), mixed and granulated with 645 g of a 6 wt % aqueous solution of hydroxypropylcellulose at the rate of 15 g/minute together with supply of air of 80° C. to prepare granules. They were milled using a screening mill (manufactured by Showa Kagaku Kikai) (screen size: 1.5 mm) to give granules in a uniform size. With regard to group B, 3.5 g of chlorpheniramine d-maleate, 48 g of dextromethorphan hydrobromide, 75 of anhydrous caffeine, 22.8 g of hesperidin, 420 g of tranexamic acid, 7.7 g of light anhydrous silicic acid and 173.8 g of cornstarch in accordance with the formulation of Table 2 were placed in a fluidized bed granulator (temperature of supplied air: 80° C.), granulated with 387 g of a 6 wt % aqueous solution of hydroxypropylcellulose at the rate of 9 g/minute and the resulting granules were milled in the same manner as above to give granules in a uniform size.

To 645 g of granules of the group A in a uniform size and 387 g of granules of the group B in a uniform size were added 143.4 g of microcrystalline cellulose, 36 g of crosscarmellose sodium and 3.6 g of magnesium stearate, the mixture was mixed for 3 minutes in a tumbler mixer (type TM-15; manufactured by Showa Kagaku Kikai) and the resulting granules for preparing tablets were treated with a rotary tablet machine (Correct 19k; manufactured by Kikusui Seisakusho) with a compression force of 15 kN/punch to manufacture tablets. At that time, a circular punch (having marks both on top and bottom) and die were used. SKS-2 was used as a basis material of the punch and its surface was subjected to a Cr-Dopé-N treatment while high-silicon steel was used as a basis material of the die (as same as in Example 1-1) and its surface was subjected to a carburization treatment (as same as in Example 1-1).

The Cr-Dopé-N treatment was invented by H.E.F. Company in France (A. Aubelt, R. Gillet, A. Gaucher and J. P. Terrat: Thin Solid Films, Vol. 108, p. 165, 1983; A. Aubelt, J. Danroc, A. Gaucher and J. P. Terrat: Thin Solid Films, Vol. 126, p. 61, 1985) and can be carried out according to the method described for example in the scientific magazine “Kata Gijyutsu” vol. 8, No. 5, pages 70 to 78 (1993, April).

### Comparative Example 1-2

The granules prepared in Example 1-2 were treated with a rotary tablet machine (Correct 19k; manufactured by Kikusui Seisakusho) with a compression force of 15 kN/punch to prepare tablets. At that time, a circular punch of 8.5 mm having marks both on top and bottom and a die were used. Both punch and die used SKS-2 as a basis material where the surface of the punch was subjected to a Cr-Dopé-N treatment while the surface of the die was untreated.

TABLE 2

| | Ex.1-2 and Comp. Ex. 1-2 |
|---|---|
| per nine tablets | [mg] |
| Group A | |
| Acetaminophen | 900.0 |
| di-Methylephedrine hydrochloride | 60.0 |
| Hesperidin | 37.2 |
| Cornstarch | 254.1 |
| Hydroxypropylcellulose | 23.2 |
| Total | 1290.0 |
| Group B | |
| Chlorpheniramine d-maleate | 3.5 |
| Dextromethorphan hydrobromide | 48.0 |
| Anhydrous caffeine | 75.0 |
| Hesperidin | 22.8 |
| Tranexamic acid | 420.0 |
| Light anhydrous silicic acid | 7.7 |
| Cornstarch | 173.8 |
| Hydroxypropylcellulose | 23.2 |
| Total | 774.0 |
| After Mixing | |
| Group A granules | 1290.0 |
| Group B granules | 774.0 |
| Microcrystallinecellulose | 286.8 |
| Crosscarmellose sodium | 72.0 |
| Magnesium stearate | 7.2 |
| Total | 2430.0 |

### Test Example 1

State of adhesion of the punch and binding in the tabletting step of Example 1-1 or 1-2 or Comparative Example 1-1 or 1-2 were observed and the result is shown in Tables 3 and 4. In Comparative Example 1-2, adhesion due to production of a low-melting substance by a depression of melting point was noted whereby it was found that, in Examples, better tabletting property was achieved as compared with Comparative Examples.

TABLE 3

| | Comp. Ex. 1-1 | Ex. 1-1 |
|---|---|---|
| Adhesion of Upper Punch | noted | none |
| Adhesion of Lower Punch | noted | none |
| Tabletting State | tabletting impossible | good |

### Example 2-1

In accordance with a method known perse, there was prepared a punch (hereinafter, referred to as “punch of the Example”) where the high-silicon steel (the same one as in Example 1-1) was used as the basis material and the carburization treatment (as same as in Example 1-1) was applied on its surface.

In order to check the releasing property of the above punch of the Example, granules for preparing tablets consisting of 33.06 parts by weight of pioglitazone hydrochloride, 76.34 parts by weight of lactose, 3.0 parts by weight of hydroxypropyl cellulose, 7.2 parts by weight of carboxymethylcellulose calcium and 0.4 part by weight of magnesium stearate was prepared by a conventional method using a fluidized bed granulator (type FD-S2; manufactured by Powrex Company) and a tumbling mixer (TM-15; manufactured by Showa Kagaku Kikai), the said granules for preparing tablets was tabletted with a compression force of 7 to 9 kN using a rotary tablet machine (Correct 19k; manufactured by Kikusui Seisakusho) equipped with the punch of the Example, i.e. the Example 1-1 or the Example 1-2, and the state of powder adhesion on the surface of the punch tip was checked by naked eye. The result is shown in Table 5.

### Comparative Example 2-1

As a comparative example for the releasing property, the granules prepared in Example 2-1 was used and compressed under the same condition as in Example 2-1 using a rotary tablet machine (Correct 19k; manufactured by Kikusui Seisakusho) equipped with the following punch and the state of powder adhesion on the surface of the punch tip was checked by naked eye. The result is shown in Table 5.

(1) SKS2 punch: a punch prepared using an alloy tool steel (SKS2) containing 95% by weight of iron as a basis material, 1% by weight of chromium, 1.5% by weight of tungsten, 1% by weight of carbon, 0.35% by weight of silicon, 0.8% by weight of manganese, 0.03% by weight of phosphorus and 0.03% by weight of sulfur.

(2) Alloy punch: a punch prepared using a sintered alloy (Japanese Patent Application No. 323,123/1997) as a basis material.

(3) Chromium plated punch: a punch where a hard chromium plating was applied by a known method per se on the surface of the SKS2 punch.

(4) TiN punch: a punch where a coating of titanium nitride (TiN) was applied by a known method per se on the surface of the SKS2 punch.

(5) DLC punch: a punch where a coating of diamond-like carbon (DLC) was applied by a known method per se on the surface of the SKS2 punch.

### Test Example 2

When compression to make tablets was carried out using the granules containing an acidic substance, powder adhesion on the surface of punch tip was noted in the case of chromium plated punch, TiN punch and DLC punch whereby the manufacture in a stable manner was difficult while, in the case of the punch of the Example, i.e. the Example 1-1 and the Example 1-2, SKS2 punch and alloy punch, powder adhesion on the surface of punch tip was not noted.

TABLE 5

| | Result of Checking the Releasing Property | | | | | |
|---|---|---|---|---|---|---|
| | Powder Adhesion on the Surface of Punch Tip | | | | | |
| | Punch | | | | | |
| Checked | of | SKS2 | Alloy | Cr Plated | | DLC |
| Stage | Exam- | Punch | Punch | Punch | TiN Punch | Punch |
| Upon | ple no | no | no | Adhesion | adhesion | ad- |
| Comple- | ad- | ad- | ad- | noted; | noted; | hesion |
| tion of | hesion | hesion | hesion | tabletting | tabletting | noted; |
| Tabletting | | | | impossible | impossible | tab- |
| | | | | | | letting |
| | | | | | | im- |
| | | | | | | possible |

### Example 2-2

In order to check the corrosion resistance of the punch of the Example, i.e. the Example 1-1 or the Example 1-2, the granules prepared by the same manner as in Example 2-1 was contacted to the punch of the Example, i.e. the Example 1-1 or the Example 1-2, and allowed to stand in a room (temperature: 20-25° C.; humidity: 40-65%) for seven days and the corroded state on the surface of the punch was checked by naked eye. The result is shown in Table 6.

### Comparative Example 2-2

As a comparative example for corrosion resistance, SKS2 punch and alloy punch were used and the state of corrosion on the surface of the punch was checked by naked eye after allowing to stand under the same condition as in Example 2-2. The result is shown in Table 6.

### Test Example 3

Granules containing an acidic substance was contacted to a punch and allowed to stand in a room whereupon a significant corrosion was noted in the SKS2 punch while, in the punch of the Example, i.e. the Example 1-1 or the Example 1-2, and in the alloy punch, no corrosion was noted.

TABLE 6

| Checked Stage | | | |
|---|---|---|---|
| upon Allowing | | | |
| to Stand | Result of Checking the Corroded State | | |
| in Room for | Punch of Example | SKS2 Punch | Alloy Punch |
| one day | no corrosion | partially corroded | no corrosion |
| seven days | no corrosion | wholly corroded | no corrosion |

### Example 2-3

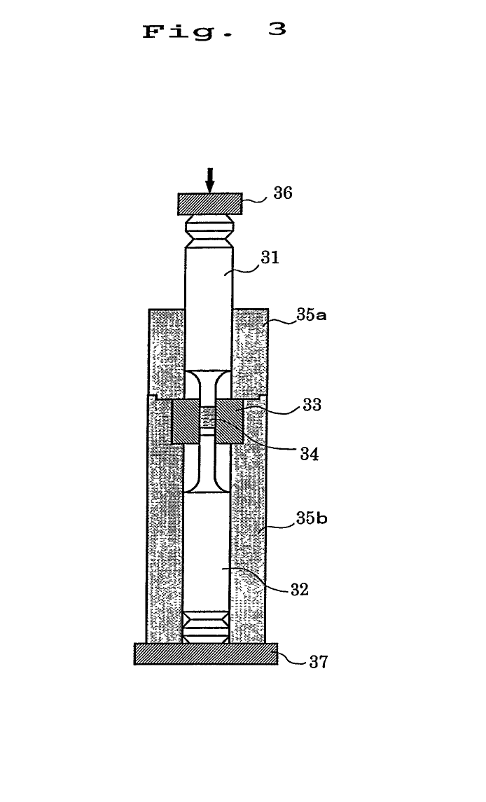

In order to check the strength of the punch of the Example, i.e. the Example 1-1 or the Example 1-2, the said punch was compressed from upside after allowing to stand as shown in FIG. 3 in an autograph (AG-100KMD; manufactured by Shimadzu Seisakusho) and the changes in the size before and after the compression for the diameter of the punch tip and for the full length were measured. The result is shown in Table 7.

### Comparative Example 2-3

As a comparative example for the strength, the compression was conducted under the same condition as in Example 2-3 using the SKS2 punch and the alloy punch and the changes in the size before and after the compression for the diameter of the punch tip and for the full length were measured. The result is shown in Table 7.

### Test Example 4

As a result of checking the changes in the size by compression of the punches, the punch of the Example, i.e. the Example 1-1 or the Example 1-2, showed the same or even better strength as compared with the SKS2 punch and the alloy punch. In the case of the alloy punch however, breakage of the punch tip was noted when compression procedure was continued for 5 hours using a rotary tabletting machine and, therefore, its application to an industrial production was concluded to be difficult.

TABLE 7

| | | Result of Strength Check (Changes in | | |
|---|---|---|---|---|
| | | Size Before and Checking After | | |
| | | Compression) | | |
| Condition and Items for the | | Punch of | | |
| Checking | | Example | SKS2 Punch | Alloy Punch |
| 4OkN/punch | Diameter (mm) | ±0 | +0.002 | +0.003 |
| | of the Punch Tip | | | |
| | Full Length (mm) | ±0 | ±0 | −0.030 |

The punch and die in accordance with the present invention where a high-silicon steel is used as a basis material and, if desired, a carburization treatment is carried out at the surface thereof show excellent corrosion resistance and releasing property in the manufacture of tablets containing a corrosive substance or an adhesive substance and there is achieved an advantage that a tablet machine suitable for an industrial product in a stable manner can be provided.

What is claimed is:

1. A punch or die for compressing granules to prepare tablets where basis material is a high-silicon steel.

2. The punch or die according to claim 1, wherein the surface of the basis material is subjected to a carburization treatment.

3. The punch or die according to claim 1 or 2, wherein it is applied to a punch (1, 2) or die (3) used for a tablet machine for the preparation of tablets containing corrosive substances or adhesive substances.

4. The punch or die according to claim 3, wherein the corrosive substance is an acidic substance.

5. The punch or die according to claim 3, wherein the adhesive substance(s) is/are one or more substance(s) selected from a group consisting of adhesive pharmacologically active substance, adhesive low-melting substance and adhesive excipient.

6. The punch or die according to claim 5, wherein the adhesive low-melting substance is resulted due to a depression of melting point.

7. A tablet machine which is characterized in being equipped with the punch or the die mentioned in claim 1 or 2.

8. A method for manufacturing tablets, characterized in that, the tablet machine mentioned in claim 7 is used during compression of granules.

9. The method according to claim 8, wherein the tablets contain corrosive substances or adhesive substances.

10. The manufacturing method according to claim 9, wherein the corrosive substance is an acidic substance.

11. The manufacturing method according to claim 9, wherein the adhesive substance(s) is/are one or more substance(s) selected from a group consisting of adhesive pharmacologically active substance, adhesive low-melting substance and adhesive excipient.

12. The manufacturing method according to claim 11, wherein the adhesive low-melting substance is resulted due to a depression of melting point.

13. Tablets which are manufactured according to the manufacturing method mentioned in any one of the claims 8 to 12.
